(19) United States
(12) Patent Application Publication
(10) Pub. No.: US 2016/0165478 A1
(43) Pub. Date: Jun. 9, 2016

(54) Methods and Apparatuses for Load Balancing in a Self-Organising Network

(71) Applicant: NOKIA SOLUTIONS AND NETWORKS OY, Espoo (FI)

(72) Inventors: Yi Zhi YAO, Beijing (CN); Ingo VIERING, Munich (DE); Krzysztof KORDYBACH, Pulawy (PL); Paolo ZANIER, Munich (DE)

(21) Appl. No.: 14/904,717

(22) PCT Filed: Aug. 2, 2013
(86) PCT No.: PCT/EP2013/066297

§ 371 Date: Jan. 13, 2016

(51) Int. Cl. H04W 28/02; H04W 28/08

(52) U.S. Cl. CPC H04W 28/021; H04W 28/08; H04W 28/0268; H04W 84/18

(57) ABSTRACT

A method including obtaining information including at least one indicator at a first cell; and using said information to determine the available capability of said first cell for load balancing between said first cell and at least one second cell in a self-organising network.

Embodiments relate to a method and an apparatus and in particular but not exclusively to a method and apparatus for load balancing in a self-organising network.

A communication system can be seen as a facility that enables communication sessions between two or more entities such as mobile communication devices and/or other stations associated with the communication system. A communication system and a compatible communication device typically operate in accordance with a given standard or specification which sets out what the various entities associated with the system are permitted to do and how that should be achieved. For example, the manner how the communication device can access the communication system and how communications shall be implemented between communicating devices, the elements of the communication network and/or other communication devices is typically defined.

In a wireless communication system at least a part of communications between at least two stations occurs over a wireless link. Examples of wireless systems include public land mobile networks (PLMN), satellite based communication systems and different wireless local networks, for example wireless local area networks (WLAN). In wireless systems a network element or network entity (NE) or access node is provided by a base station. The radio coverage area of a base station is known as a cell, and therefore the wireless systems are often referred to as cellular systems. In some systems, for example a 3GPP standard system, a base station access node is called Node B (NB) or an enhanced Node B (eNB).

A user can access the communication system by means of an appropriate communication device. A communication device of a user is often referred to as user equipment (UE). A communication device is provided with an appropriate signal receiving and transmitting arrangement for enabling communications with other parties. A communication device may be arranged to communicate, for example, data for carrying communications such as voice, electronic mail (email), text message, multimedia, for enabling internet access and so on. Users may thus be offered and provided numerous services via their communication devices. The communication connection can be provided by means of one or more data bearers.

In wireless systems a communication device provides a transceiver station that can communicate with the access node and/or another communications device.

Network management is a complex task. Complexity arises on the one side from the number of network elements (NEs) that have to be deployed and managed, and on the other side from interdependencies between the configuration and the status of the deployed network elements in terms of performance, faults, etc. In a heterogeneous network the variety of deployed technologies and their proprietary operational paradigms are difficult to handle. The configuration, optimization and troubleshooting of the management of the network therefore requires high expertise and operational management workflows to be typically performed by human operators supported by software tools. However, such manual and semi-automated management is time-consuming, error-prone, and potentially unable to react quickly enough to network changes and thus expensive.

It has been a goal of network management designers to attempt to automate operation, administration and management (OAM) functions by the deployment of “Self Organizing Networks” (SON).

In a first aspect there is provided a method comprising: obtaining information comprising at least one indicator at a first cell; and using said information to determine the available capability of said first cell for load balancing between said first cell and at least one second cell in a self-organising network.

Preferably said obtaining information comprises one of: receiving said information, and retrieving said information from a memory.

Preferably said at least one indicator is received from an administration and management node.

Preferably said at least one indicator comprises a parameter for indicating an extent to which said first cell can impact existing non-guaranteed bit-rate services when offering its available capacity for load balancing.

Preferably said parameter is expressed as at least one of a percentage value and an enumerated value.

Preferably said enumerated value is one of “All”, “High”, “Medium”, “Low” and “No”.

Preferably said at least one parameter is indicative of a capacity reserved by said first cell, said reserved capacity being unavailable for load balancing.

Preferably said determination is propagated in response to a request from said at least one second cell.

Preferably said determination is carried out at a base station.

Preferably said available capacity comprises a composite available capacity.

In a second aspect there is provided a computer program comprising computer executable instructions which when run on one or more processors perform the method of the first aspect.

In a third aspect there is provided an apparatus comprising: at least one processor; and at least one memory including computer program code; the at least one memory and the computer program code configured to, with the at least one processor, cause the apparatus at least to: obtain information comprising at least one indicator; and use said information to determine the available capability of a first cell controlled by said apparatus for load balancing between said first cell and at least one second cell in a self-organising network.

Preferably said apparatus is configured to one of receive said information and retrieve said information from a memory of said apparatus.

Preferably said apparatus is configured to receive said at least one indicator from an administration and management node.

Preferably said at least one indicator comprises a parameter for indicating an extent to which said first cell can impact existing non-guaranteed bit-rate services when offering its available capacity for load balancing.

Preferably said parameter is expressed as at least one of a percentage value and an enumerated value.

Preferably said enumerated value is one of “All”, “High”, “Medium”, “Low” and “No”.

Preferably said at least one parameter is indicative of a capacity reserved by said first cell, said reserved capacity being unavailable for load balancing.

Preferably said apparatus is configured to propagate said determination in response to a request from said at least one second cell.

Preferably said apparatus comprises a base station.

Preferably said available capacity comprises a composite available capacity.

In a fourth aspect there is provided an apparatus comprising means for obtaining information comprising at least one indicator; and means for using said information to determine the available capability of a first cell controlled by said apparatus for load balancing between said first cell and at least one second cell in a self-organising network.

Preferably said apparatus is configured to one of: receive said information, and retrieve said information from a memory of said apparatus.

Preferably said apparatus is configured to receive said at least one indicator from an administration and management node.

Preferably said at least one indicator comprises a parameter for indicating an extent to which said first cell can impact existing non-guaranteed bit-rate services when offering its available capacity for load balancing.

Preferably said parameter is expressed as at least one of a percentage value and an enumerated value.

Preferably said enumerated value is one of “All”, “High”, “Medium”, “Low” and “No”.

Preferably said at least one parameter is indicative of a capacity reserved by said first cell, said reserved capacity being unavailable for load balancing.

Preferably said apparatus comprises means for propagating said determination in response to a request from said at least one second cell.

Preferably said apparatus comprises a base station.

Preferably said available capacity comprises a composite available capacity.

In a fifth aspect there is provided a method comprising: providing information comprising at least one indicator to a first cell; said indicator for enabling said first cell to determine an available capability for cell-load balancing between said first cell and at least one second cell in a self-organising network.

Preferably said at least one indicator is provided to a base station.

Preferably said at least one indicator comprises a parameter for indicating an extent to which said first cell can impact existing non-guaranteed bit-rate services when offering its available capacity for load balancing.

Preferably said parameter is expressed as one of a percentage value and an enumerated value.

Preferably said enumerated value comprises one of “All”, “High”, “Medium”, “Low” and “No”.

Preferably said at least one parameter is indicative of a capacity reserved by said first cell, said reserved capacity being unavailable for load balancing.

Preferably said available capacity comprises a composite available capacity.

In a sixth aspect there is provided a computer program comprising computer executable instructions which when run on one or more processors perform the method of the fifth aspect.

In a seventh aspect there is provided an apparatus comprising: at least one processor; and at least one memory including computer program code; the at least one memory and the computer program code configured to, with the at least one processor, cause the apparatus at least to: provide information comprising at least one indicator to a first cell; said indicator for enabling said first cell to determine an available capability for cell-load balancing between said first cell and at least one second cell in a self-organising network

Preferably said at least one indicator comprises a parameter for indicating an extent to which said first cell can impact existing non-guaranteed bit-rate services when offering its available capacity for load balancing.

Preferably said apparatus is configured to express said parameter as one of a percentage value and an enumerated value.

Preferably said enumerated value comprises one of “All”, “High”, “Medium”, “Low” and “No”.

Preferably said at least one parameter is indicative of a capacity to be reserved by said first cell, said reserved capacity being unavailable for load balancing.

Preferably said available capacity comprises a composite available capacity.

In an eighth aspect there is provided an apparatus comprising means for providing information comprising at least one indicator to a first cell; said indicator for enabling said first cell to determine an available capability for cell-load balancing between said first cell and at least one second cell in a self-organising network.

Preferably said at least one indicator comprises a parameter for indicating an extent to which said first cell can impact existing non-guaranteed bit-rate services when offering its available capacity for load balancing.

Preferably said apparatus comprises means for expressing said parameter as one of a percentage value and an enumerated value.

Preferably said enumerated value comprises one of “All”, “High”, “Medium”, “Low” and “No”.

Preferably said at least one parameter is indicative of a capacity to be reserved by said first cell, said reserved capacity being unavailable for load balancing.

Preferably said available capacity comprises a composite available capacity.

In a ninth aspect there is provided a method comprising: obtaining information for determining cell-load balancing between a first cell and at least one second cell in a self-organising network, wherein said information comprises a model of load in at least one of said first cell and said second cell for a given period; and using said information for determining cell-load balancing between said first cell and said at least one second cell.

Preferably said obtaining information comprises one of: receiving said information, and retrieving said information from a memory.

Preferably said method comprises providing measurements related to load to an administration and management node.

Preferably at least one of said first cell and said second cell store said model in a memory.

Preferably said model is received from an operation, administration and management node.

Preferably said model is received in each given period.

Preferably said load comprises a traffic load.

Preferably said load is represented by a relative value of the total available capacity.

In a tenth aspect there is provided a computer program comprising computer executable instructions which when run on one or more processors perform the method of the ninth aspect.

In an eleventh aspect there is provided an apparatus comprising: at least one processor; and at least one memory including computer program code; the at least one memory and the computer program code configured to, with the at least one processor, cause the apparatus at least to: obtain information for determining cell-load balancing between a first cell and at least one second cell in a self-organising network, wherein said information comprises a model of load in at least one of said first cell and said at least one second cell for a given period; and use said information to determine cell-load balancing between said first cell and said at least one second cell.

Preferably said apparatus is configured to one of: receive said information, and retrieve said information from a memory of said apparatus.

Preferably said apparatus is configured to provide measurements related to load to an administration and management node.

Preferably said apparatus is configured to store said model in a memory.

Preferably said apparatus is configured to receive said model from an operation, administration and management node.

Preferably said apparatus is configured to receive said model in each given period. Preferably said load comprises a traffic load.

Preferably said load is represented by a relative value of the total available capacity.

In a twelfth aspect there is provided an apparatus comprising means for obtaining information for determining cell-load balancing between a first cell and at least one second cell in a self-organising network, wherein said information comprises a model of load in at least one of said first cell and said at least one second cell for a given period; and means for using said information to determine cell-load balancing between said first cell and said at least one second cell.

Preferably said apparatus is configured to one of: receive said information, and retrieve said information from a memory of said apparatus.

Preferably said apparatus comprises means for providing measurements related to load to an administration and management node.

Preferably said apparatus comprises means for storing said model in a memory.

Preferably said apparatus is configured to receive said model from an operation, administration and management node.

Preferably said apparatus is configured to receive said model in each given period.

Preferably said load comprises a traffic load.

Preferably said load is represented by a relative value of the total available capacity.

In a thirteenth aspect there is provided a method comprising: providing information to a first cell for determining cell-load balancing between said first cell and at least one second cell in a self-organising network; and wherein said information comprises a model of load in at least one of said first cell and said at least one second cell for a given period.

Preferably the method comprises receiving measurements related to load from at least one of said first cell and said at least one second cell.

Preferably said model is provided to a base station.

Preferably said model is provided in each given period.

Preferably said measurements related to load are received in each given period.

Preferably said load is representative of a traffic load.

Preferably said load is representative of a relative value of the total available capacity.

In a fourteenth aspect there is provided a computer program comprising computer executable instructions which when run on one or more processors perform the method of the thirteenth aspect.

In a fifteenth aspect there is provided an apparatus comprising at least one processor; and at least one memory including computer program code; the at least one memory and the computer program code configured to, with the at least one processor, cause the apparatus at least to: provide information to a first cell for determining cell-load balancing between said first cell and at least one second cell in a self-organising network; and wherein said information comprises a model of load in at least one of said first cell and said at least one second cell for a given period.

Preferably the apparatus is configured to receive measurements related to load from at least one of said first cell and said at least one second cell.

Preferably said apparatus is configured to provide said model to a base station.

Preferably said apparatus is configured to provide said model in each given period.

Preferably said apparatus is configured to receive said measurements related to load in each given period.

Preferably said load is representative of a traffic load.

Preferably said load is representative of a relative value of the total available capacity.

In a sixteenth aspect there is provided an apparatus comprising means for providing information to a first cell for determining cell-load balancing between said first cell and at least one second cell in a self-organising network; and wherein said information comprises a model of load in at least one of said first cell and said at least one second cell for a given period.

Preferably said apparatus comprises means for receiving measurements related to load from at least one of said first cell and said at least one second cell.

Preferably said apparatus is configured to provide said model to a base station.

Preferably said apparatus is configured to provide said model in each given period.

Preferably said apparatus is configured to receive said measurements related to load in each given period.

Preferably said load is representative of a traffic load.

Preferably said load is representative of a relative value of the total available capacity.

Embodiments will now be described in further detail, by way of example only, with reference to the following examples and accompanying drawings, in which:

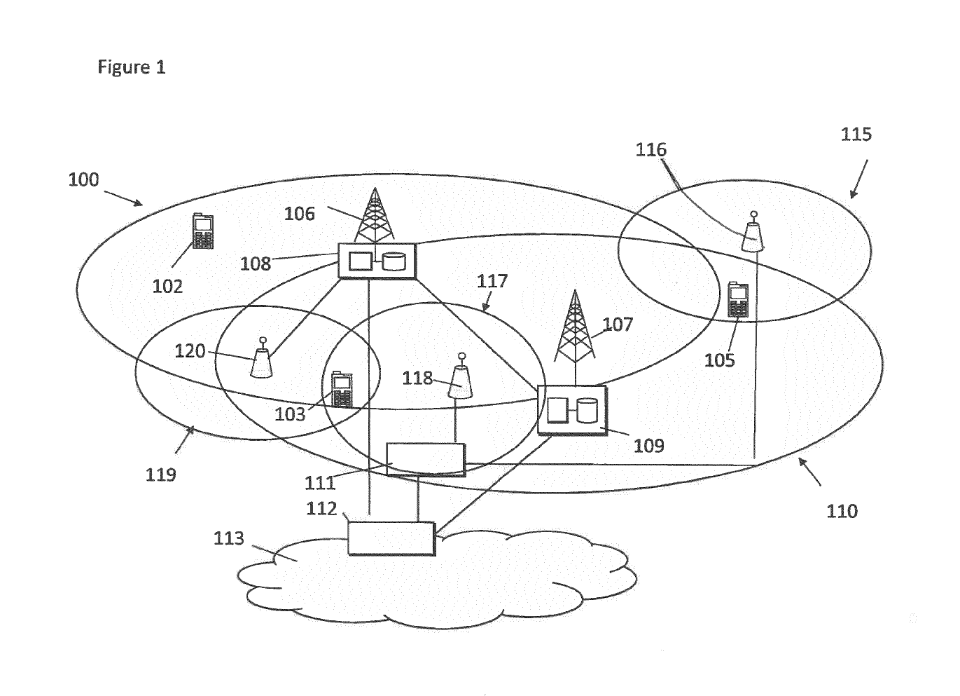

FIG. 1 shows a schematic diagram of a network according to some embodiments;

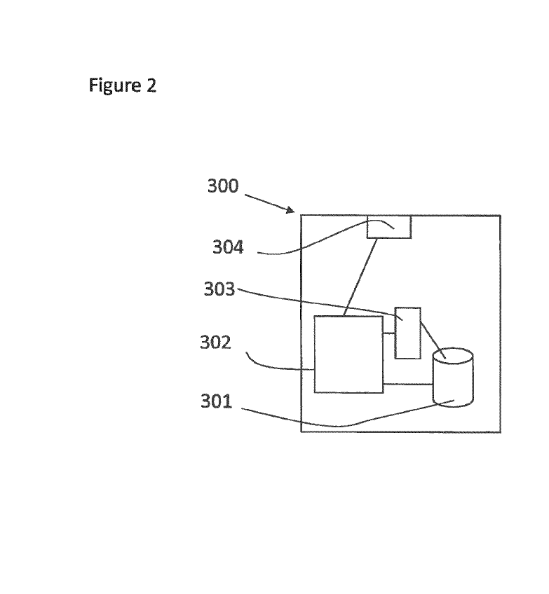

FIG. 2 is a schematic diagram of a controller apparatus according to some embodiments;

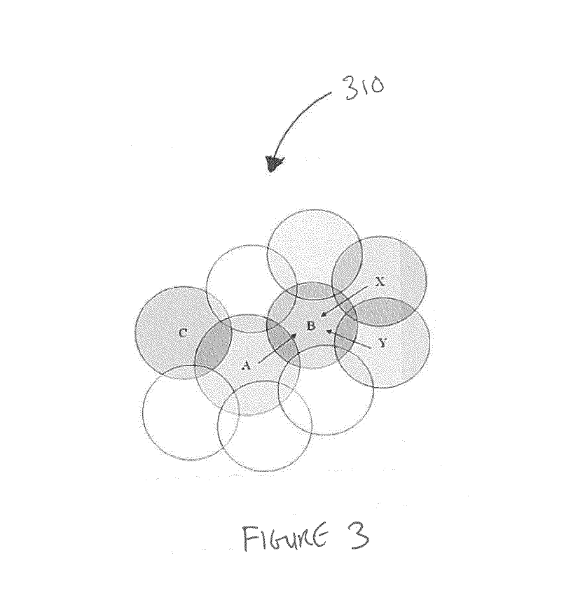

FIG. 3 is a schematic diagram of a cell cluster according to an embodiment;

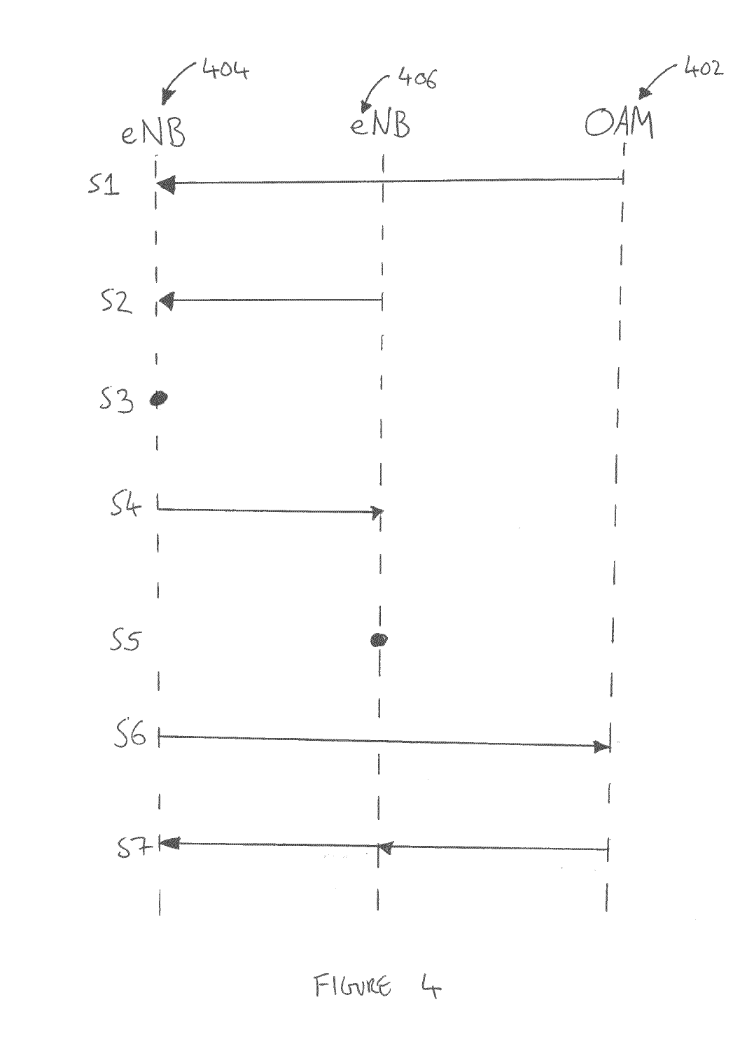

FIGS. 4 to 6 are signalling flow diagrams according to some embodiments.

In the following certain exemplifying embodiments are explained with reference to a wireless or mobile communication system serving mobile communication devices. Before explaining in detail the exemplifying embodiments, certain general principles of a wireless communication system and mobile communication devices are briefly explained with reference to FIGS. 1 and 2 to assist in understanding the technology underlying the described examples.

In a wireless communication system mobile communication devices or user equipment (UE) 102, 103, 105 are provided wireless access via at least one base station or similar wireless transmitting and/or receiving node or point. In the FIG. 1 example two overlapping access systems or radio service areas of a cellular system 100 and 110 and three smaller radio service areas 115, 117 and 119 provided by base stations 106, 107, 116, 118 and 120 are shown. Each mobile communication device and station may have one or more radio channels open at the same time and may send signals to and/or receive signals from more than one source. It is noted that the radio service area borders or edges are schematically shown for illustration purposes only in FIG. 1. It shall also be understood that the sizes and shapes of radio service areas may vary considerably from the shapes of FIG. 1. A base station site can provide one or more cells. A base station can also provide a plurality of sectors, for example three radio sectors, each sector providing a cell or a subarea of a cell. All sectors within a cell can be served by the same base station.

Base stations are typically controlled by at least one appropriate controller apparatus so as to enable operation thereof and management of mobile communication devices in communication with the base stations. In FIG. 1 control apparatus 108 and 109 is shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

In FIG. 1 stations 106 and 107 are shown as connected to a wider communications network 113 via gateway 112. A further gateway function may be provided to connect to another network.

The smaller stations 116, 118 and 120 can also be connected to the network 113, for example by a separate gateway function and/or via the controllers of the macro level stations. In this example, stations 116 and 118 are connected via a gateway 111 whilst station 120 connects via the controller apparatus 108. In some embodiments, the smaller stations may not be provided.

An appropriate mobile communication device may be provided by any device capable of sending and receiving radio signals. Non-limiting examples include a mobile station (MS) such as a mobile phone or what is known as a ‘smart phone’, a computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The communication devices 102, 103, 105 can access the communication system based on various access techniques, such as code division multiple access (CDMA), or wideband CDMA (WCDMA). Other examples include time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long-term evolution (LTE) of the Universal Mobile Telecommunications System (UMTS) radio-access technology. The various development stages of the 3GPP LTE specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and may provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (Worldwide Interoperability for Microwave Access).

The various nodes and functions discussed in embodiments further below may be provided by an apparatus of the type shown in FIG. 2. FIG. 2 shows an example apparatus. This apparatus may be used to provide one or more of a: base station of any kind; SON coordinator; OAM function etc. The term “base station” may refer to any type of base station, including but not limited to a macro-eNB and a micro-eNB. The term “micro-eNB” may be used interchangeably with small-cell-eNB, home-eNB, micro-eNB, femto-eNB etc. The controller apparatus 300 is typically provided with at least one memory 301, at least one data processor 302, 303 and at least one input/output interface 304.

Self-Organizing Networks (SON) allow for automated network management of some communication systems such as LTE or LTE-A, as well as for multi-radio technology networks known as heterogeneous networks (HetNet). SON may provide one or more of self-configuration, self-optimization and healing. Self-configuration deals with the auto-connectivity and initial configuration of new network elements such as radio base stations. Self-optimization targets the optimal operation of the network. Self-optimization triggers one or more automatic actions where there is one or more of a change in demand for services, there is a change in user mobility and usual application usability changes, with the result that one or more network parameters need to be adjusted. Self-optimization may alternatively or additionally be used for one or more of energy saving and mobility robustness optimization. The SON may alternatively or additionally provide self-healing which may provide one or more of automatic anomaly detection and fault diagnosis. Areas related to SON may comprise one or more of Traffic Steering (TS) and Energy Savings Management (ESM).

SON aims at replacing conventional offline manual network operation and optimization processes (and associated tools). SON functions may provide individual use cases in one or more of the areas mentioned above in an “online” distributed fashion. Instances of a certain SON function type may operate within a specific narrow scope on a relatively small part of data available at a network element or OAM (operation, administration and maintenance) system. SON functions may be supplied by one or more different vendors. One or more SON functions may be integrated within and for a specific network deployment.

A SON function may have a monitoring part that models one or more certain conditions. These one or more conditions may be filtered and/or detected from the input data. The input data may be for example performance data such as one or more of measurements, counters, and Key Performance Indicators. If the monitoring part detects one or more conditions in the input data, a configuration determination part triggers which attempts to determine a better configuration of the resources under consideration. The proposed configuration may be provided to one or more configuration deployment entities. The SON function may thus react to one or more detected conditions.

A SON function may have a generic function area associated therewith. The function area may comprise all network resources which may be manipulated by a SON function to achieve a desired goal.

SON Load Balancing (which may also be referred to as Mobility Load Balancing) is defined as a distributed SON feature in 3GPP TS 36.300 and 36.423, with operation, administration and management (OAM) control and monitoring capability as specified in 3GPP TS 32.522 and 32.762. Load balancing functionality consists of load information exchange, handover execution, and mobility setting adjustment.

An example situation requiring load balancing is shown in FIG. 3.

FIG. 3 shows ten overlapping cells in part of a self-organising network 310. Each cell is controlled by a base station (not shown). For the purposes of explanation five cells are considered, namely cells A, B, C, X and Y.

In this example cell A has a relatively high load. “Load” may be considered the amount of traffic or the relative value of the total CAC (Composite Available Capacity) within the cell. So a cell with a “high” load will be considered to be at or near its capacity with respect to the amount of traffic it can handle. In this example the neighbouring cells B and C have relatively lower loads than cell A, and therefore are potential candidates for accepting load distributed from cell A.

Cells X and Y also neighbour cell B. In this example cells X and Y have a relatively high load compared to cell B, and therefore cells X and Y may benefit from distributing some of their load to cell B. It will be appreciated that if all of cells A, C, X and Y distribute load to cell B at the same time (known as a “race” condition) then cell B may suddenly find itself overloaded. Accordingly it is desirable to coordinate SON load balancing between the cells.

However, each of the cells may have different criteria or may use different algorithms for determining how much capacity is to be made available for load balancing purposes. This may be exacerbated in inter-vendor cases i.e. where different operators control neighbouring cells. In some examples the same cell may advertise different availabilities for load balancing to different neighbouring cells. In some cases a cell may provide insufficient capacity for load balancing to its neighbour cells, and in other cases a cell may provide too much capacity for load balancing to its neighbour cells.

Accordingly an operator may not know whether an available capacity offered by a cell is accurate. This may make it difficult for determining whether the actual load balancing capacity available is in line with expectations, and also makes it difficult to determine associated parameters such as to what extent guaranteed bit rate (GBR) users and non-GRB services are allowed to be impacted when load balancing.

Current systems may also suffer from only being aware of “current” or instantaneous load information of its neighbour cells. That is a cell (or a node operating the cell) may not have knowledge of how load trends may change in the short term or long term future with respect to neighbouring cells. Therefore a cell may improperly distribute some of its load to a neighbour cell because it is unaware of an upcoming change in the load situation for that cell to which it has offloaded.

Accordingly a load balancing action may cause frequent “ping-pong” or circuitous load balancing in some cases where for example the load of the target cell is quickly increased after the load balancing. This would cause the target cell to then try and quickly decrease the load level (if it has exceeded its capacity), leading to the above-mentioned “ping-pong” or unsteady load levels. As briefly discussed above a load balancing action may also cause similar issues when multiple cells (e.g. cells A, C, X and Y) all distribute load to another cell (e.g. cell B) at the same time leading to a sudden rise of the load in cell B. This may cause cell B to then simply send the load back to cells A, C, X and Y (if the load balancing caused cell B to reach or exceed its capacity). Accordingly In such a case the initial load balancing operation would be pointless.

In another example a high load cell (e.g. cell A) may be prevented from distributing its traffic load if the neighbour cells have incorrectly communicated that they do not have sufficient capacity to share the load, thus causing cell A to maintain an unnecessarily high load.

Composite available capacity (CAC) enables a base station to inform a neighbour of the capacity that it offers for load balancing purposes. The present inventors have identified that it would be desirable to optimise configuration of the CAC to enhance load balancing in self optimising networks.

The embodiments discussed below describe mechanisms for determining cell load distribution between neighbouring cells.

A first embodiment is described with respect to FIG. 4. In a first step S1 the OAM 402 sends to a base station 404 controlling a first cell an “eagerness” indicator. This indicator indicates how the base station 404 should configure the cell in terms of its willingness to impact existing service users when offering its available capacity for load balancing to other cells. Such existing service users may be non-guaranteed bit rate users. It will of course be understood that the term “eagerness” is used by way of example only and that the term is used simply to describe an indicator which is used to indicate a willingness or eagerness of a cell to offer its available capacity for load sharing. Upon receipt of the eagerness indicator the eNB 404 may store the indicator in a memory thereof. In another embodiment the eNB 404 is preconfigured with the eagerness or willingness indicator, in which case step S1 is not required. It will also be appreciated that eNB 406 may also receive an “eagerness” indicator from the OAM 402, or be pre-configured with such an indicator.

In embodiments the eagerness or willingness could be specified with a number of predetermined settings e.g. “All/High/Medium/Low/No”, or with a percentage value from 0 to 100. Such values may be considered a parameter of the indicator. With this parameter the base station 404 and/or base station 406, or OAM 402, or other network node is able to control how aggressive the load balancing in its network is. In terms of the parameter the extreme value 0 or “no” could refer to a situation in which no load balancing at all is allowed in the cell. At the other end of the scale the values 100% or “All” would mean that a cell is willing to give all of its available capacity for load balancing. If the eagerness is expressed in a percentage then it can, for example, be defined as an average level of the non-guaranteed bit rate services are “squeezed” to make room for load coming from a neighbouring overloaded cell.

In this example, at step S2 base station 404 receives a request from base station 406 controlling another cell for a load balancing operation. This may be a neighbouring cell, but could be any other cell. That is in this situation the base station 406 is controlling a cell which needs to offload some of its traffic.

At step S3 the base station 404 uses the received and/or stored information to determine the CAC that can be used for load balancing, or in other words the amount of load that base station 404 can take from base station 406, if any. In this respect the base station 404 may use any of the following information, or any combination thereof: eagerness indicator of base station 404, “current” load of base station 404, “current” load of base station 406.

Following the determination, at step S4 the base station 404 sends a message to base station 406 informing base station 406 how much CAC can be used for load balancing from base station 406 to base station 404 (if any). The offload (if any) takes place at step S5.

Following the traffic offload there will be a different cell load at each of base stations 404 and 406. Accordingly at step S6 the base station 404 sends an update to OAM 402 of the updated load scenario. It will be understood that this update message can be sent from either or both of base stations 404 and 406.

At step S7 the OAM 402 may optionally send updated eagerness indicators to one or both of base stations 404 and 406 in light of the updated load scenario.

It will of course be understood that the embodiment of FIG. 4 has been simplified for the purposes of explanation and that in other embodiments any number of base stations and OAMs may be involved in the determination. For example the base station 404 may have to consider information received from a number of base stations and/or OAMs when making load balancing determinations.

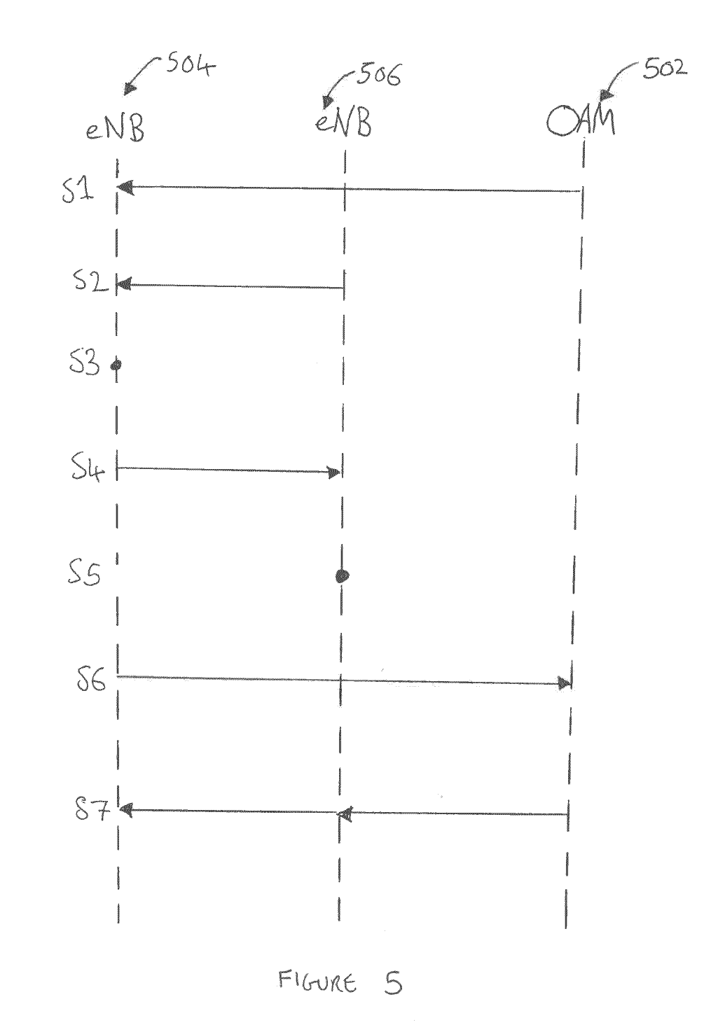

A further embodiment will now be described with respect to FIG. 5. Some of the steps of this embodiment are similar to those described with respect to the embodiment of FIG. 4.

At step S1 the OAM 502 sends a message to the base station 504. This message comprises information including a “margin” indicator, which indicates the minimum capacity that has to be reserved at base station 504 apart from the capacity it is allowed for load balancing. At step S1 the OAM 502 may also send such a margin indicator to the base station 506. Alternatively one or both of base station 504 and 506 may be pre-configured with a margin indicator in which case step 1 may not be required.

The “margin” is in some embodiments specified with a parameter such as a percentage value from 0 to 100. A value of zero would mean that the respective base station has no capacity available for load balancing, whereas a value of 100% would mean that it has 100% of its capacity available for load balancing. By way of example a value of 30% would mean that the respective base station must reserve 30% of its capacity for requirements other than load balancing i.e. 70% of its capacity is available for load balancing.

At step S2 the base station 506 sends a request to base station 504 for load balancing, for example if base station 506 is at or near its capacity and needs to offload traffic.

At step S3 the base station 504 uses the information to determine the load balancing necessary e.g. how much CAC can be used for load balancing, in other words the load that can be offloaded from base station 506 to base station 504 (if any). The information may comprise one or both of the margin indicators associated with base stations 504 and 506, as well as information regarding the “current” cell loading at base stations 504 and 506.

Following this determination the base station 504 sends a message to base station 506 informing base station 506 how much CAC can be used for load balancing from base station 506.

At step S5 the load balancing operation takes place. That is the traffic is distributed between the base station 506 and the base station 504.

At step S6 the base station 504 sends an update message to OAM 502 informing the OAM 502 of the new cell loading. This message could also be sent from base station 506, or could be sent from both base stations 504 and 506.

At step S7 the OAM may send updated margin indicators to the base stations 504 and 506 in light of the updated cell loading scenario.

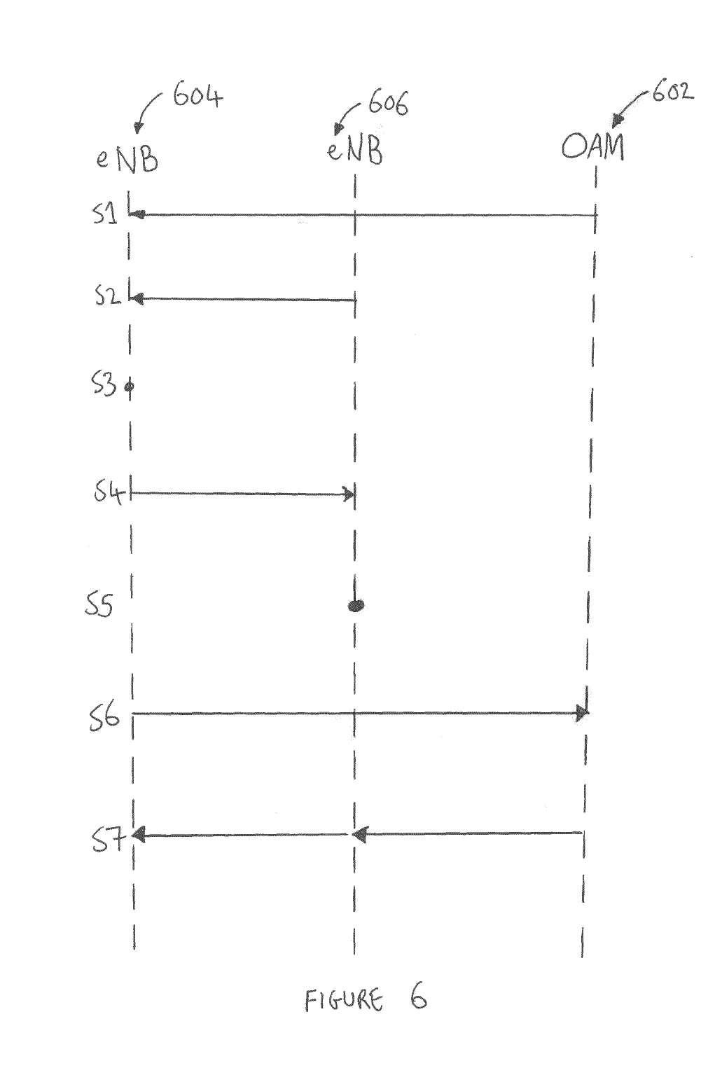

A third embodiment will now be described with respect to FIG. 6.

At step S1 the base station 604 is provided from the OAM 602 with a traffic/load model of itself and/or other cells. The other cells may be neighbouring cells. At step S1 the base station 606 may also be provided with a traffic/load model of itself and/or other cells, which may be neighbouring cells.

Each traffic/load model provides a base station with predicted load profiles of certain (e.g. neighbouring) cells over a given period. For example the traffic/load model may represent the traffic volume in 15 minute segments over a one week period. It will of course be appreciated that these segments and periods are by way of example only and can differ by any amount. The traffic load model will take in to account times when a neighbouring cell is expected to be busy i.e. have a high traffic level, and when the cell is expected to have a low traffic volume. For example a cell which is close to a train station may be expected to have a relatively high traffic load during rush hour, and a relatively low traffic load overnight and at weekends. Alternatively the base station 604 and 606 may be pre-configured with the traffic/load models.

At step S2 the base station 606 sends a load balancing request to base station 604. Along with this step, the base station 606 may use the traffic/load models of base station 606 and/or base station 604 to determine a load distribution amount to request.

At step S3 the base station 604 uses the traffic/load models to determine how much CAC can be used for load balancing from base station 606. By virtue of the traffic/load models the base station 604 can take into account not only the instantaneous traffic situation, but can also consider how the traffic is likely to vary over a given future period, and can take this into consideration when offering the CAC for load distribution.

At step S4, following the determination, the base station 604 informs base station 606 of the load balancing determination and accordingly how much CAC can be used for load balancing from the base station 606 (if any).

At step S5 the load balancing operation takes place and the load is distributed between base stations 604 and 606.

At step S6 the base station 604 informs OAM 602 of the new cell-loading scenario. As with the other embodiments this update message may come from one or both of base stations 604 and 606.

At step S7 the OAM 602 may send new traffic/load models to the base stations 604 and 606 in light of the updated cell loading scenario.

As part of this embodiment each cell may regularly report its traffic/load with a certain granularity to the OAM 602. Based on such reports the OAM 602 can then build improved traffic/load models for each cell for a given period, and can then provide the updated traffic/load model to the cells in question. In some embodiments the OAM 602 may provide such information once at the beginning of each period. For example if the period has been set at one week, then at the beginning of each week the OAM may send an updated traffic/load model based upon the actual traffic reported during the previous week or weeks.

It will be appreciated that any of the embodiments described with respect to FIGS. 4, 5 and 6 can be implemented individually or in any combination. For example a base station may use information related to any one or more of the above described eagerness indicator, margin indicator, and traffic/load model when determining load balancing distribution. In some embodiments different parameters may be used for different cells. For example, a cell A may be performing a determination of cell-load distribution with cells B, C and D. Cell A may use an eagerness indicator associated with cell B, a margin indicator associated with cell C, and a traffic/load model associated with cell D, or any other combination thereof.

In some embodiments a cell may be associated with more than one indicator and/or load model. For example a single cell may have one or more of an eagerness indicator, a margin indicator and a traffic/load model associated therewith. Weightings may be given to each of the indicators/models e.g. priority may be given to achieving the parameters of the eagerness indicator over the traffic/load model, and vice versa.

Furthermore the determination may, in some embodiments, be made at a node other than the base station. For example the determination may be made at the OAM, with the instruction for load distribution then being transmitted to each base station. The determination may also take place at a network node other than the OAM. For example implementation may be carried out in the NMS (Network Management System), or the EMS (Element Management System), or a separate SON server.

It will be appreciated that some embodiments may optimise load balancing in self-organising networks.

An appropriately adapted computer program code product or products may be used for implementing the embodiments, when loaded on an appropriate data processing apparatus, for example for determining geographical boundary based operations and/or other control operations. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof. Embodiments of the inventions may thus be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

It is also noted herein that while the above describes exemplifying embodiments of the invention, there are several variations and modifications which may be made to the disclosed solution without departing from the scope of the present invention.

1. A method comprising:
obtaining information comprising at least one indicator at a first cell; and
using said information to determine the available capability of said first cell for load balancing between said first cell and at least one second cell in a self-organising network.

2-3. (canceled)

4. A method as set forth in claim 1, wherein said at least one indicator comprises a parameter for indicating an extent to which said first cell can impact existing non-guaranteed bit-rate services when offering its available capacity for load balancing.

5. (canceled)

6. A method as set forth in claim 4, wherein said at least one parameter is indicative of a capacity reserved by said first cell, said reserved capacity being unavailable for load balancing.

7-8. (canceled)

9. An apparatus comprising
at least one processor;
and at least one memory including computer program code;
the at least one memory and the computer program code configured to, with the at least one processor, cause the apparatus at least to:
obtain information comprising at least one indicator; and
use said information to determine the available capability of a first cell controlled by said apparatus for load balancing between said first cell and at least one second cell in a self-organising network.

10-11. (canceled)

12. An apparatus as set forth in claim 9, wherein said at least one indicator comprises a parameter for indicating an extent to which said first cell can impact existing non-guaranteed bit-rate services when offering its available capacity for load balancing.

13. An apparatus as set forth in claim 12 wherein said parameter is expressed as at least one of a percentage value and an enumerated value.

14. An apparatus as set forth in claim 12, wherein said at least one parameter is indicative of a capacity reserved by said first cell, said reserved capacity being unavailable for load balancing.

15. (canceled)

16. A method comprising:
providing information comprising at least one indicator to a first cell;
said indicator for enabling said first cell to determine an available capability for cell-load balancing between said first cell and at least one second cell in a self-organising network.

17. A method as set forth in claim 16 wherein said at least one indicator comprises a parameter for indicating an extent to which said first cell can impact existing non-guaranteed bit-rate services when offering its available capacity for load balancing.

18. A method as set forth in claim 4 wherein said parameter is expressed as at least one of a percentage value and an enumerated value.

19-20. (canceled)

21. An apparatus comprising
at least one processor;
and at least one memory including computer program code;
the at least one memory and the computer program code configured to, with the at least one processor, cause the apparatus at least to:
provide information comprising at least one indicator to a first cell;
said indicator for enabling said first cell to determine an available capability for cell-load balancing between said first cell and at least one second cell in a self-organising network

22. An apparatus as set forth in claim 21 wherein said at least one indicator comprises a parameter for indicating an extent to which said first cell can impact existing non-guaranteed bit-rate services when offering its available capacity for load balancing.

23-24. (canceled)

25. A method comprising:
obtaining information for determining cell-load balancing between a first cell and at least one second cell in a self-organising network, wherein said information comprises a model of load in at least one of said first cell and said second cell for a given period;
and using said information for determining cell-load balancing between said first cell and said at least one second cell.

26-30. (canceled)

31. An apparatus comprising
at least one processor;
and at least one memory including computer program code;
the at least one memory and the computer program code configured to, with i o the at least one processor, cause the apparatus at least to:
obtain information for determining cell-load balancing between a first cell and at least one second cell in a self-organising network, wherein said information comprises a model of load in at least one of said first cell and said at least one second cell for a given period;
and use said information to determine cell-load balancing between said first cell and said at least one second cell.

32-35. (canceled)

36. A method comprising:
providing information to a first cell for determining cell-load balancing between said first cell and at least one second cell in a self-organising network; and
wherein said information comprises a model of load in at least one of said first cell and said at least one second cell for a given period.

37-40. (canceled)

41. An apparatus comprising
at least one processor;
and at least one memory including computer program code;
the at least one memory and the computer program code configured to, with the at least one processor, cause the apparatus at least to:
provide information to a first cell for determining cell-load balancing between said first cell and at least one second cell in a self-organising network; and
wherein said information comprises a model of load in at least one of said first cell and said at least one second cell for a given period.

42-44. (canceled)
